(19) United States
(12) Patent Application Publication
(10) Pub. No.: US 2017/0129357 A1
(43) Pub. Date: May 11, 2017

(54) Automatic Charging System for Electric Vehicles

(71) Applicant: Jianhui Zheng, Fremont, CA (US)

(72) Inventor: Jianhui Zheng, Fremont, CA (US)

(21) Appl. No.: 15/299,689

(22) Filed: Oct. 21, 2016

(30) Foreign Application Priority Data
Nov. 10, 2015 (CN) 201510760058.0

(51) Int. Cl. B60L 11/18; H02J 7/00; H02J 7/02

(52) U.S. Cl. CPC B60L 11/1827; B60L 11/1816; B60L 11/182; H02J 7/025; H02J 7/0021

(57) ABSTRACT

The disclosed subject matter presents an automatic charging system for electric vehicles. The automatic charging system includes a vehicle-mounted control unit, a charging control unit, a vehicle-mounted receiving terminal, a charging terminal and a power supply device. The charging terminal seeks target, connects and charges as guided by an ultrasonic or infrared signal from the receiving terminal. By designing an automatic charging system for electric vehicles and by making use of ultrasonic or infrared technology, the disclosed subject matter achieves intelligent and automated charging of electric vehicles for the entire process from the beginning to the end, and can automatically charge a plurality of electric vehicles, respectively, according to a desired sequence.

This application claims the benefit of priority to Chinese Patent Application No. 201510760058.0, filed Nov. 10, 2015. These and all other referenced extrinsic materials are incorporated herein by reference in their entirety. Where a definition or use of a term in a reference that is incorporated by reference is inconsistent or contrary to the definition of that term provided herein, the definition of that term provided herein is deemed to be controlling.

### FIELD OF THE INVENTION

The present invention relates to the electric automobile charging field, and in particular to an automatic charging system for electric automobiles.

### BACKGROUND

The following description includes information that may be useful in understanding the present invention. It is not an admission that any of the information provided herein is prior art or relevant to the presently claimed invention, or that any publication specifically or implicitly referenced is prior art.

Electric automobiles are used more and more popularly across the world, which makes significant contributions to eliminating environmental pollution and mitigating the global warming. However, there are some drawbacks and inconveniences in using electric automobiles. In addition to the range issue of batteries for electric automobiles, the most prominent issue is the inconvenience in charging the batteries. Every day when an automobile returns to a garage, the charging plug needs to be plugged manually into the charging port of the electric automobile, and the charging plug is pulled out when the charging is completed. Such actions need to be repeated every day, which leads to troublesome and inconvenient use relatively to conventional automobiles. If a plurality of electric automobiles in one garage but there is only one charging pole in the garage, then one has to get up in mid-night to change automobiles for charging, making it even more inconvenient in use. Conventional automobiles do not have such an inconvenience in use.

All publications herein are incorporated by reference to the same extent as if each individual publication or patent application were specifically and individually indicated to be incorporated by reference. Where a definition or use of a term in an incorporated reference is inconsistent or contrary to the definition of that term provided herein, the definition of that term provided herein applies and the definition of that term in the reference does not apply.

In some embodiments, the numbers expressing quantities of ingredients, properties such as concentration, reaction conditions, and so forth, used to describe and claim certain embodiments of the invention are to be understood as being modified in some instances by the term “about.” Accordingly, in some embodiments, the numerical parameters set forth in the written description and attached claims are approximations that can vary depending upon the desired properties sought to be obtained by a particular embodiment. In some embodiments, the numerical parameters should be construed in light of the number of reported significant digits and by applying ordinary rounding techniques. Notwithstanding that the numerical ranges and parameters setting forth the broad scope of some embodiments of the invention are approximations, the numerical values set forth in the specific examples are reported as precisely as practicable. The numerical values presented in some embodiments of the invention may contain certain errors necessarily resulting from the standard deviation found in their respective testing measurements.

As used in the description herein and throughout the claims that follow, the meaning of “a,” “an,” and “the” includes plural reference unless the context clearly dictates otherwise. Also, as used in the description herein, the meaning of “in” includes “in” and “on” unless the context clearly dictates otherwise.

The recitation of ranges of values herein is merely intended to serve as a shorthand method of referring individually to each separate value falling within the range. Unless otherwise indicated herein, each individual value is incorporated into the specification as if it were individually recited herein. All methods described herein can be performed in any suitable order unless otherwise indicated herein or otherwise clearly contradicted by context. The use of any and all examples, or exemplary language (e.g. “such as”) provided with respect to certain embodiments herein is intended merely to better illuminate the invention and does not pose a limitation on the scope of the invention otherwise claimed. No language in the specification should be construed as indicating any non-claimed element essential to the practice of the invention.

Groupings of alternative elements or embodiments of the invention disclosed herein are not to be construed as limitations. Each group member can be referred to and claimed individually or in any combination with other members of the group or other elements found herein. One or more members of a group can be included in, or deleted from, a group for reasons of convenience and/or patentability. When any such inclusion or deletion occurs, the specification is herein deemed to contain the group as modified thus fulfilling the written description of all Markush groups used in the appended claims.

### SUMMARY OF THE INVENTION

The object of the present invention is to solve the problems of the prior art by providing an automatic charging system for electric automobiles so as to achieve intelligent and automated charging of electric automobiles for the entire process from the beginning to the end.

An automatic charging system for electric vehicles, comprising a vehicle-mounted control unit, a charging control unit, a vehicle-mounted receiving terminal, a charging terminal and a power supply device; the vehicle-mounted control unit detects the electric quantity of an electric automobile, and sends out a connecting to charge command or a charge ending command via a wireless signal; the charging control unit receives the connecting to charge command or the charge ending command via the wireless signal from the vehicle-mounted control unit, and controls the charging terminal to connect, charge, end charging and return to the initial state; the vehicle-mounted receiving terminal comprises an ultrasonic or infrared transmitter, which is controlled by the vehicle-mounted control unit, the vehicle-mounted control unit sends out a charge command, and then the vehicle-mounted receiving terminal guides the charging terminal to connect therewith and receives charging by transmitting ultrasonic wave or infrared ray; the charging terminal comprises an ultrasonic or infrared receiver to receive commands from the charging control unit for connection, charging, ending charging and returning to the initial state, and during connection, receives the ultrasonic wave or infrared ray transmitted by the vehicle-mounted receiving terminal for connection therewith; the power supply device provides power to the charging terminal.

Furthermore, the charging control unit may receive a plurality of commands from multiple vehicle-mounted control units mounted on different electric vehicles, and according to a sorting method inputted manually, control the charging terminal to charge the electric vehicles that have sent out the command one by one.

The charging control unit may be fixedly installed at a location close to a parking place and controls the charging terminal by wired or wireless means.

The charging control unit and the charging terminal may also be combined in one device.

The charging terminal of some embodiments comprises a charging coil and the receiving terminal may be a receiving coil.

The charging terminal of some embodiments further comprises an obstacle avoiding device.

The power supply device of some embodiments comprises a conductive pad disposed at a parking space.

The system may further comprise a guide track and a crossbar; the guide track is fixedly disposed at a parking space, the crossbar is movably installed on the guide track, and the charging terminal is movably installed on the crossbar.

Relative to the prior art, the technical solution according to the present invention has the following advantageous effects:

Through interaction between a vehicle-mounted control unit and a charging control unit, the present invention achieves automatic request and automatic response; by guiding the charging terminal to seek target, connect and charge by means of an ultrasonic or infrared signal from the receiving terminal, it achieves automatic target seeking, connection and charging during charging.

By receiving and sorting requests from a plurality of vehicle-mounted control units through the charging control unit, it achieves automatic charging for a plurality of electric automobiles, and solves the problem of inconvenience in charging a plurality of electric automobiles.

By fixedly installing the charging control unit at a location close to a parking place, a user is allowed to more conveniently pre-adjust the charging control unit and set up relevant parameters.

By combining the charging control unit and the charging terminal in one device, it can save the space for installing the charging control unit.

By setting the charging terminal to be a charging coil and setting the receiving terminal to be a receiving coil, non-contact charging may be achieved.

By providing an obstacle avoiding device at the charging terminal, the charging terminal may automatically avoid obstacles during movement.

By setting the power supply device to be a conductive pad disposed at a parking space, the charging terminal may perform charging without a cord, which avoids inconvenience caused by entangled cords.

By providing a guide track and a crossbar at a parking space and installing the charging terminal on the crossbar capable of two-dimensional movement, the charging terminal does not need a cord, and at the same time, the on effect is more reliable than that of a conductive pad, and moreover, it is favorable for theft prevention. When it is used in a public rapid charging station, a driver can charge without getting off the automobile, which is more convenient than filling up gas for a conventional automobile.

Various objects, features, aspects and advantages of the inventive subject matter will become more apparent from the following detailed description of preferred embodiments, along with the accompanying drawing figures in which like numerals represent like components.

### BRIEF DESCRIPTION OF THE DRAWINGS

FIG. 1 is a schematic diagram of an automatic charging system according to Embodiment 1;

FIG. 2 is a schematic diagram of an automatic charging system according to Embodiment 2;

FIG. 3 is a schematic diagram of an automatic charging system according to Embodiment 3 of the present invention;

FIG. 4 is a schematic diagram of a conductive pad in Embodiment 3 of the present invention;

FIG. 5 is a schematic diagram of the charging terminal mobile mechanism in Embodiment 4 of the present invention.

### DETAILED DESCRIPTION

It should be noted that any language directed to a computer should be read to include any suitable combination of computing devices, including servers, interfaces, systems, databases, unit, agents, peers, engines, modules, controllers, or other types of computing devices operating individually or collectively. One should appreciate the computing devices comprise a processor configured to execute software instructions stored on a tangible, non-transitory computer readable storage medium (e.g., hard drive, solid state drive, RAM, flash, ROM, etc.). The software instructions preferably configure the computing device to provide the roles, responsibilities, or other functionality as discussed below with respect to the disclosed apparatus. In especially preferred embodiments, the various servers, systems, databases, or interfaces exchange data using standardized protocols or algorithms, possibly based on HTTP, HTTPS, AES, public-private key exchanges, web service APIs, known financial transaction protocols, or other electronic information exchanging methods. Data exchanges preferably are conducted over a packet-switched network, the Internet, LAN, WAN, VPN, or other type of packet switched network.

The following discussion provides many example embodiments of the inventive subject matter. Although each embodiment represents a single combination of inventive elements, the inventive subject matter is considered to include all possible combinations of the disclosed elements. Thus if one embodiment comprises elements A, B, and C, and a second embodiment comprises elements B and D, then the inventive subject matter is also considered to include other remaining combinations of A, B, C, or D, even if not explicitly disclosed.

In some embodiments, the numbers expressing quantities of ingredients, properties such as concentration, reaction conditions, and so forth, used to describe and claim certain embodiments of the invention are to be understood as being modified in some instances by the term “about.” Accordingly, in some embodiments, the numerical parameters set forth in the written description and attached claims are approximations that can vary depending upon the desired properties sought to be obtained by a particular embodiment. In some embodiments, the numerical parameters should be construed in light of the number of reported significant digits and by applying ordinary rounding techniques. Notwithstanding that the numerical ranges and parameters setting forth the broad scope of some embodiments of the invention are approximations, the numerical values set forth in the specific examples are reported as precisely as practicable. The numerical values presented in some embodiments of the invention may contain certain errors necessarily resulting from the standard deviation found in their respective testing measurements.

As used herein, and unless the context dictates otherwise, the term “coupled to” is intended to include both direct coupling (in which two elements that are coupled to each other contact each other) and indirect coupling (in which at least one additional element is located between the two elements). Therefore, the terms “coupled to” and “coupled with” are used synonymously.

Unless the context dictates the contrary, all ranges set forth herein should be interpreted as being inclusive of their endpoints, and open-ended ranges should be interpreted to include commercially practical values. Similarly, all lists of values should be considered as inclusive of intermediate values unless the context indicates the contrary.

The disclosed subject matter presents an automatic charging system that automatically charges multiple electric vehicles (e.g., cars, boats, planes, etc.) using a single power supply without user interference. The present disclosed subject matter will be further described in detail below with reference to the accompanying drawings and embodiments. It should be understood that specific examples described herein are only used to describe the present invention, rather than to limit the present invention.

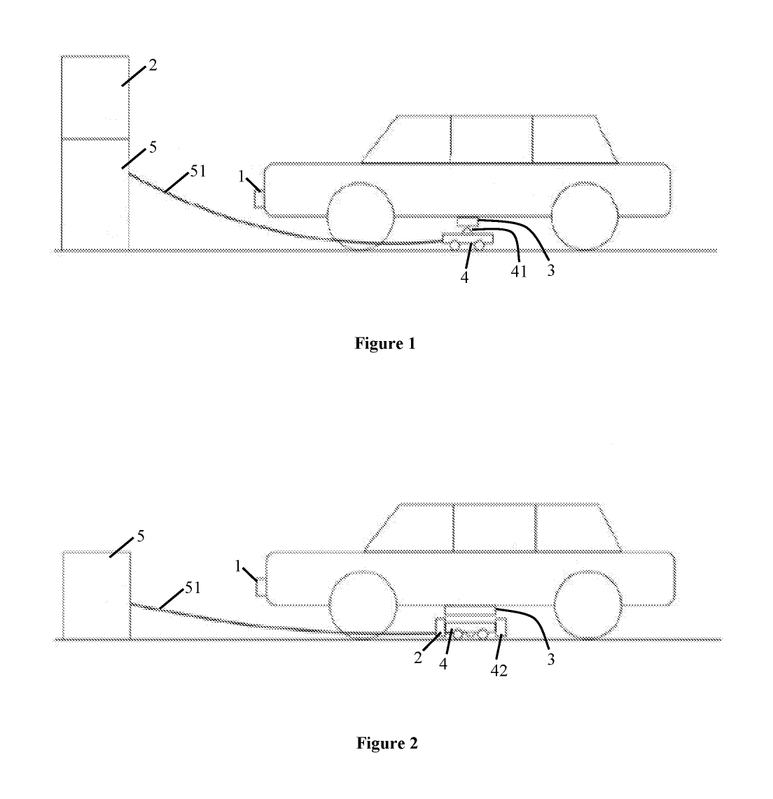

In Embodiment 1 of the present subject matter as shown in FIG. 1, a vehicle-mounted control unit 1 is installed on the body of an electric vehicle. The vehicle-mounted control unit 1 can be implemented as a specially designed circuitry for performing the functions of the unit, or as a general processor with memory storing software instructions that when executed by the processor, causes the processor to perform the functions of the unit. In some embodiments, the vehicle-mounted control unit 1 is connected to at least one battery of the electric vehicle.

In some embodiments, the vehicle-mounted control unit 1 also comprises a sensor for detecting when the electric vehicle is in proximity of a charging control unit 2 (e.g., when the electric vehicle enters into a garage with a charging station of some embodiments, etc.). When the vehicle-mounted control unit 1 detects that the vehicle is in proximity of a charging control unit 2, the vehicle-mounted control unit 1 is programmed to determine an electricity charge level of the battery of the electric vehicle.

If the vehicle-mounted control unit 1 determines that the electric vehicle needs charging (e.g., the determined electricity charge level of the battery is below a pre-determined threshold, such as 20% of its full capacity, 10% of its full capacity, 5% of its full capacity, etc.), the vehicle-mounted control unit 1 is programmed to transmit a charge command to a charging control unit 2 and instruct a vehicle-mounted receiving terminal 3 to transmit ultrasonic wave or infrared ray. In some embodiments, the charging control unit 2 is programmed to instruct a charging terminal 4 via a wireless signal to seek the receiving terminal 3 according to the ultrasonic or infrared signal transmitted by the receiving terminal 3 and to connect with the receiving terminal 3.

Terminal 3 is part of the battery circuitry within the vehicle and is connected to the battery of the vehicle. In some embodiments, the charging terminal 4 includes mechanism to move around with respect to a power supply 5 such that the charging terminal 4 could independently and autonomously move toward the receiving terminal 3 attached to the electric vehicle in response to receiving the instruction from the charging control unit 2. Once the charging terminal 4 has moved from an initial location (e.g., near the power supply 5, etc.) to a location close to the receiving terminal 3, the charging terminal 4 is programmed to extend out a cone-shaped charging plug 41 into a funnel-shaped charging outlet of the receiving terminal 3. With the cone-shaped charging plug 41 and the funnel-shaped charging outlet, it can be ensured that the charging plug is accurately inserted into the charging outlet.

After inserting the cone-shaped charging plug 41 into the funnel-shaped charging outlet, the charging terminal 4 is programmed to start charging the battery of the electric vehicle. Furthermore, the receiving terminal 3 is also programmed to shut down the ultrasonic or infrared signal. The vehicle control unit 1 is programmed to continuously monitor the electricity charge level of the battery of the electric vehicle. When the vehicle control unit determines that the electricity charge level of the battery of the electric vehicle has reached a predetermined threshold (e.g., 100%, 98%, 90% of full capacity of the battery), the vehicle control unit is programmed to send a termination signal to the charging control unit 2. In response to the termination signal, the charging control unit 2 is programmed to instruct the charging terminal 4 via a wireless signal to terminate the charging, retrieve the cone-shaped charging plug 41, and return to the initial location. In the present embodiment, the power supply device 5 provides power to the charging terminal 4 via a cord 51. In some embodiments, the power supply device 5 includes an electricity socket on a wall of a building. Through the embodiment above, the system achieves functions of automatic vehicle target seeking, automatic connection, automatic charging and automatic returning to the initial position.

In the present embodiment, the mode in which the receiving terminal 3 guides the charging terminal 4 may be either ultrasonic (such as the technical solution according to the Chinese Patent CN103076591A) or infrared (such as the technical solution according to the Chinese Patent CN101648377A), or a combination of the two technologies.

It is contemplated that the automatic charging system of some embodiments can be configured to automatically charge batteries of multiple electric vehicles. For example, when multiple electric vehicles having their respective vehicle control units are parked near the charging control unit 2, the respective vehicle control units are programmed to transmit a charge command to the charging control unit 2 when they determine that the batteries of the vehicles are below the predetermined threshold. In some embodiment, when the charging control unit 2 receives charge commands from multiple vehicle-mounted control units 1 (each of them corresponds to a different electric vehicle), the charging control unit 2 is programmed to control the charging terminal 4 to charge the electric vehicles that have sent out the charge command one by one according to a sorting algorithm (e.g., first-in-first-out, sorting ascending based on electricity charge level, etc.). The charging control unit 2 is programmed to first compile a list of electric vehicles waiting to be charged in a sorted list according to the sorting algorithm. The charging control unit 2 is then programmed to instruct the charging terminal 4 to move to the vehicle-mounted receiving terminal 3 of the first vehicle in the list, connect to the vehicle-mounted receiving terminal 3, charge the battery of the vehicle, then move to the vehicle-mounted receiving terminal 3 of the next vehicle on the list, and so on. There are many sorting methods, which may charge the one with the lowest electric quantity, or arrange charging according to the time sequence in which the charge commands are sent out, or charge whichever one first as determined artificially. In such a case, it achieves automatic charging for a plurality of electric automobiles and solves the problem of inconvenient charging for a plurality of electric automobiles.

In Embodiment 2 shown in FIG. 2, what is different from Embodiment 1 is that the charging control unit 2 and the charging terminal 4 are installed on the same device, which can save the space for installing the charging control unit.

In some embodiments, the charging terminal 4 includes an elevating charge coil, and the receiving terminal 3 includes a receiving coil. In some embodiments, the charging terminal 4 is configured to perform non-contact charging on the receiving terminal 3 via electromagnetic induction, thereby achieving non-contact charging. In addition, the charging terminal 4 is further provided with an obstacle avoiding device 42, there are many kinds of such an obstacle avoiding device 42, which can avoid through video and video analysis techniques, avoid through infrared ray, or avoid through ultrasonic wave techniques, and the advantage of installation with an obstacle avoiding device is that the charging terminal 4 is allowed to find the receiving terminal 3 with no obstacle. Detail on different obstacle avoidance technique can be found in Chinese Patent Publication CN101492072.

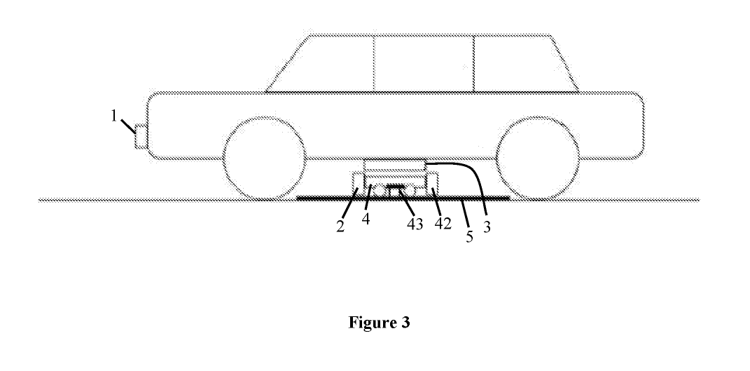

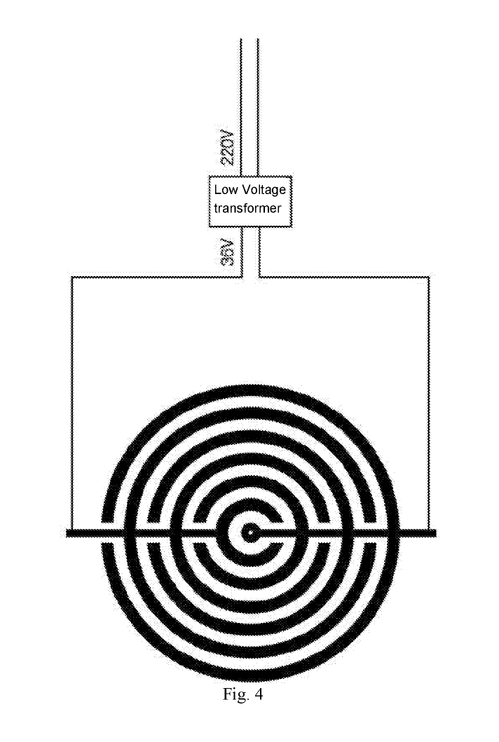

In Embodiment 3 shown in FIG. 3 and FIG. 4, the power supply device 5 is a conductive pad, the form of such a conductive pad may be as shown in FIG. 4, or may be other similar forms, and other forms shall be deemed as equivalent technologies. The conductive pad is connected to a commercial power supply via a low voltage transformer, the voltage of the conductive pad is within the safety voltage of 36 V to avoid electric shock accidents. The charging terminal is further provided with a disc-shaped conductive rod 43, the conductive rod is distributed on the disc edge in rings on the disc-shaped conductive rod 43. After successful target seeking, the conductive rod begins to contact the conductive pad and is switched on, the specific method may be that any conductive rod may be used as the starting point, if all conductive rods could not be connected to it, then said conductive rod is not in contact with the electric circuit on the conductive pad, and then the test is repeated on the next conductive rod, if it is detected that other conductive rods may be connected to it to form a voltage, then all other conductive rods are set to be as one pole, the test starts again with any one of these other conductive rods, and all conductive rods in contact therewith are the other pole. As a result, it can be learned whether all conductive rods are switched on, and which pole is switched on. The advantage of providing a conductive pad is that the charging terminal may perform charging without a cord, which avoids inconvenience caused by entangled cords.

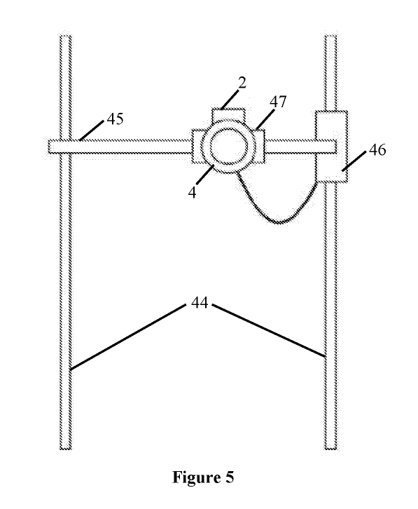

In Embodiment 4 shown in FIG. 5, by installing the charging terminal 4 on a sliding block 47, the sliding block 47 is controlled by the charging terminal 4. The sliding block 47 may slide on a crossbar 45. The crossbar 45 is fixedly connected to a sliding block 46, and the sliding block 46 is also controlled by the charging terminal. The sliding block 46 may slide on a guide track 44. The guide track 44 may be placed at the central position of the parking space. The charging terminal 4 may be powered through a cord. The guide track 44, the crossbar 45, the sliding block 46 and the sliding block 47 form a two-dimensional positioning system within a limited range of the parking space. The charging terminal 4 is guided by ultrasonic wave or infrared ray from the receiving terminal 3, controls the sliding blocks 46 and 47 to seek target and position underneath the receiving terminal 3, and connects to charge. The advantage of this embodiment is that the charging terminal does not need cords, and at the same time, the on effect is more reliable than that of a conductive pad, and it is favorable for theft prevention. When it is used in a public rapid charging station, a driver can charge without getting off the automobile, which is more convenient than filling up gas for a conventional automobile.

Preferred embodiments of the present invention are described above, but it should be understood that the present invention is not limited to the above embodiments, which should not be deemed as exclusion of other embodiments. With the teaching from the present invention, modifications made by those skilled in the art by combining with known knowledge or the prior art or knowledge shall all be encompassed by the present invention.

It should be apparent to those skilled in the art that many more modifications besides those already described are possible without departing from the inventive concepts herein. The inventive subject matter, therefore, is not to be restricted except in the spirit of the appended claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced. Where the specification claims refers to at least one of something selected from the group consisting of A, B, C . . . and N, the text should be interpreted as requiring only one element from the group, not A plus N, or B plus N, etc.

What is claimed is:

1. An automatic charging system for an electric vehicle, comprising:
a power supply;
a charging control unit;
a vehicle-mounted receiving terminal coupled with a battery of the electric vehicle and comprising an ultrasonic or infrared transmitter;
a vehicle-mounted control unit coupled to the battery of the electric vehicle and programmed to (i) detect an electricity charge level of the electric vehicle, and when the detected electricity charge level is below a predetermined threshold, (a) transmit a charge command to the charging control unit and (b) instruct the vehicle-mounted receiving terminal to provide, via the ultrasonic or infrared transmitter, a wireless signal;
a charging terminal coupled with the power supply, the charging terminal having an ultrasonic or infrared receiver configured to receive the wireless signal from the vehicle-mounted receiving terminal and a moving mechanism configured to move with respect to the power supply;
wherein the charging control unit is programmed to instruct, in response to receiving the charge command from the vehicle-mounted control unit, the charging terminal (i) to move from an initial location toward the vehicle receiving terminal based on the wireless signal and (ii) to connect to the vehicle receiving terminal, charge the battery of the electric vehicle, terminate charging, and returning to the initial location.

2. The automatic charging system of claim 1, wherein the charging control unit is programmed to (i) receive a plurality of commands received from vehicle-mounted control units associated with different electric vehicles, (ii) sort the plurality of commands according to a sorting algorithm, and (iii) instruct the charging terminal to charge the different electric vehicles in an order according to the sorted commands.

3. The automatic charging system of claim 1, wherein the charging control unit is programmed to control the charging terminal by wired or wireless means.

4. The automatic charging system of claim 1, wherein the charging control unit and the charging terminal are implemented within a single device.

5. The automatic charging system of claim 1, wherein the charging terminal comprises a charging coil and wherein the vehicle-mounted receiving terminal comprises a receiving coil.

6. The automatic charging system of claim 5, wherein the charging terminal and the vehicle-mounted receiving terminal are configured to perform non-contact charging of the battery.

7. The automatic charging system of claim 1, wherein the charging terminal further comprises an obstacle avoiding device.

8. The automatic charging system of claim 1, wherein the power supply device comprises a conductive pad.

9. The automatic charging system of claim 1, further comprises:
a guide track fixedly disposed at a parking space; and
a crossbar movably installed on the guide track, wherein the charging terminal is movably installed on the crossbar.
